(19) United States
(12) Patent Application Publication
(10) Pub. No.: US 2025/0187966 A1
(43) Pub. Date: Jun. 12, 2025

(54) FRONT-ZONE DUAL-ELECTRODE NON-EQUIDISTANT KILNS AND OPERATION METHODS THEREOF

(71) Applicant: CAIHONG DISPLAY DEVICES CO., LTD., Xianyang (CN)

(72) Inventors: Wei YANG, Xianyang (CN); Chao YU, Xianyang (CN); Jian XU, Xianyang (CN)

(73) Assignee: CAIHONG DISPLAY DEVICES CO., LTD., Xianyang (CN)

(21) Appl. No.: 18/970,825

(22) Filed: Dec. 5, 2024

Related U.S. Application Data
(63) Continuation-in-part of application No. PCT/CN2024/092911, filed on May 13, 2024.

(30) Foreign Application Priority Data
Dec. 6, 2023 (CN) 202311667583.9

(51) Int. Cl. C03B 5/235; C03B 5/18; C03B 5/24

(52) U.S. Cl. CPC C03B 5/235; C03B 5/18; C03B 5/24

(57) ABSTRACT

A front-zone dual-electrode non-equidistant kiln comprises a pool wall that forms a clarification zone, a homogenization zone, and pre-melting zones. The pre-melting zones and the homogenization zone are in communication with the homogenization zone and the clarification zone, respectively. A total width of the pre-melting zones is greater than widths of the clarification zone and the homogenization zone. Electrodes are arranged on the pool wall on two sides of each of the clarification zone, the homogenization zone, and the pre-melting zones. A spacing between electrodes on two sides of the pre-melting zones is less than a spacing between electrodes on two sides of the clarification zone and a spacing between electrodes on the two sides of the homogenization zone. The pool wall is provided with a discharge port and feed ports. The feed ports and the discharge port are in communication with the pre-melting zones and the clarification zone, respectively.

### CROSS-REFERENCE TO RELATED APPLICATIONS

This application is a continuation-in-part of International Application No: PCT/CN2024/092911, filed on May 13, 2024, which claims priority to Chinese Patent Application No. 202311667583.9, filed on Dec. 6, 2023, the entire contents of each of which are hereby incorporated by reference.

### TECHNICAL FIELD

The present disclosure relates to the field of substrate glass manufacturing, and in particular, to front-zone dual-electrode non-equidistant kilns and methods for operating the same.

### BACKGROUND

A glass kiln is an essential melting device in the glass manufacturing industry. The kiln is one of the most important and critical pieces of equipment in a production process of substrate glass, primarily used to melt glass powder into high-quality molten glass, which is then processed through other procedures to produce substrate glass.

From a clarification zone to a pre-melting zone of the kiln, a degree of glass melting gradually decreases, and resistivity of the molten glass is increasingly affected by a cold material. However, as the lead-out volume of the molten glass increases, the feed volume of glass also rises, leading to more pronounced fluctuations in the resistivity of the molten glass, which may result in fluctuations in the melting process in the pre-melting zone, and even cause electrodes in the pre-melting zone to be unable to be powered, that is, the “power off” phenomenon occurs, thereby severely affecting the operational stability of the kiln and the quality of products.

Therefore, it is necessary to provide a front-zone dual-electrode non-equidistant kiln to reduce the “power off” phenomenon and enhance the operational stability of the kiln.

### SUMMARY

One of the embodiments of the present disclosure provides a front-zone dual-electrode non-equidistant kiln. The front-zone dual-electrode non-equidistant kiln may comprise a pool wall that may be configured to form a clarification zone, a homogenization zone, and a plurality of pre-melting zones. The plurality of pre-melting zones may be in communication with the homogenization zone, and the homogenization zone may be in communication with the clarification zone. A total width of the pre-melting zones may be greater than a width of the clarification zone and a width of the homogenization zone. A plurality of electrodes may be arranged on the pool wall on two sides of each of the clarification zone, the homogenization zone, and the pre-melting zones. A spacing between electrodes on the two sides of the pre-melting zones may be less than a spacing between electrodes on the two sides of the clarification zone and a spacing between electrodes on the two sides of the homogenization zone. The pool wall may be provided with a discharge port and a plurality of feed ports. The plurality of feed ports may be in communication with the pre-melting zones, and the discharge port may be in communication with the clarification zone.

In some embodiments, a transition zone may be formed between the pre-melting zones and the homogenization zone.

In some embodiments, the width of the clarification zone may be equal to the width of the homogenization zone.

In some embodiments, the pool wall may be provided with a breast wall, and a crown may be arranged on the breast wall.

In some embodiments, the front-zone dual-electrode non-equidistant kiln may further comprise a plurality of ultrasonic components. The plurality of ultrasonic components may be arranged on an outer side of the pool wall corresponding to the pre-melting zones, the homogenization zone, and the clarification zone. Each of the plurality of ultrasonic components may include a transmitting unit and a receiving unit. The transmitting unit may be configured to emit an ultrasonic wave, and the receiving unit may be configured to collect feedback ultrasonic data.

In some embodiments, the front-zone dual-electrode non-equidistant kiln may further comprise a plurality of current measuring instruments. Each of the plurality of current measuring instruments may be connected in series with one of the plurality of electrodes and configured to measure data of a current passing through the electrode.

In some embodiments, the front-zone dual-electrode non-equidistant kiln may further comprise a voltage controller. The voltage controller may be connected to the plurality of electrodes and configured to adjust a voltage of the plurality of electrodes.

In some embodiments, the front-zone dual-electrode non-equidistant kiln may further comprise a plurality of automatic feeding gates and an automatic discharge gate. The plurality of automatic feeding gates may be provided at the plurality of feed ports, respectively, and configured to control a feeding speed. The automatic discharge gate may be provided at the discharge port and configured to control a discharge speed.

In some embodiments, the front-zone dual-electrode non-equidistant kiln may further comprise a processor that is communicatively connected with a plurality of ultrasonic components, a plurality of current measuring instruments, a voltage controller, a plurality of automatic feeding gates, and an automatic discharge gate.

One of the embodiments of the present disclosure provides a method for operating the front-zone dual-electrode non-equidistant kiln disclosed in the present disclosure. The method may comprise introducing glass powder into the plurality of pre-melting zones through the plurality of feed ports and pre-melting the glass powder using the plurality of electrodes to form molten glass; thoroughly mixing and homogenizing the molten glass entering from the pre-melting zones in the homogenization zone; and pre-clarifying homogenized molten glass in the clarification zone and discharging pre-clarified molten glass through the discharge port.

One of the embodiments of the present disclosure provides a non-transitory computer-readable storage medium storing computer instructions. When the computer instructions are executed by a processor, the processor implements the method for operating the front-zone dual-electrode non-equidistant kiln disclosed in the present disclosure.

### BRIEF DESCRIPTION OF THE DRAWINGS

The present disclosure will be further illustrated by way of exemplary embodiments, which will be described in detail through the accompanying drawings. These embodiments are not limiting, and in these embodiments the same numbering indicates the same structure, wherein:

FIG. 1 is a top cross-sectional view of an exemplary front-zone dual-electrode non-equidistant kiln according to some embodiments of the present disclosure;

FIG. 2a is a top view of an exemplary automatic feeding gate of a front-zone dual-electrode non-equidistant kiln according to some embodiments of the present disclosure;

FIG. 2b is a top view of an exemplary automatic discharge gate of a front-zone dual-electrode non-equidistant kiln according to some embodiments of the present disclosure;

FIG. 2c is a side view of an exemplary automatic feeding gate of a front-zone dual-electrode non-equidistant kiln according to some embodiments of the present disclosure;

FIG. 3 is a front view of an exemplary front-zone dual-electrode non-equidistant kiln according to some embodiments of the present disclosure;

FIG. 4 is a side view of an exemplary front-zone dual-electrode non-equidistant kiln according to some embodiments of the present disclosure;

FIG. 5a is a schematic diagram showing a connection between a current measuring instrument and an electrode of an exemplary front-zone dual-electrode non-equidistant kiln according to some embodiments of the present disclosure;

FIG. 5b is a schematic diagram showing a connection between a voltage controller and an electrode of an exemplary front-zone dual-electrode non-equidistant kiln according to some embodiments of the present disclosure;

FIG. 6 is a block diagram of components of an exemplary front-zone dual-electrode non-equidistant kiln according to some embodiments of the present disclosure; and

FIG. 7 is a flowchart of an exemplary process for operating a front-zone dual-electrode non-equidistant kiln according to some embodiments of the present disclosure.

### DETAILED DESCRIPTION

In order to provide a clearer understanding of the technical solutions of the embodiments described in the present disclosure, a brief introduction to the drawings required in the description of the embodiments is given below. It is evident that the drawings described below are merely some examples or embodiments of the present disclosure, and for those skilled in the art, the present disclosure may be applied to other similar situations without exercising creative labor. Unless otherwise indicated or stated in the context, the same reference numerals in the drawings represent the same structures or operations.

It should be understood that the terms “system,” “device,” “unit,” and/or “module” used herein are ways for distinguishing different levels of components, elements, parts, or assemblies. However, if other terms can achieve the same purpose, they may be used as alternatives.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to the embodiments described herein. It should be understood that the operations may not necessarily be performed in the exact sequence depicted. Instead, the operations may be performed in reverse order or concurrently. Additionally, other operations may be added to these processes, or one or more operations may be removed.

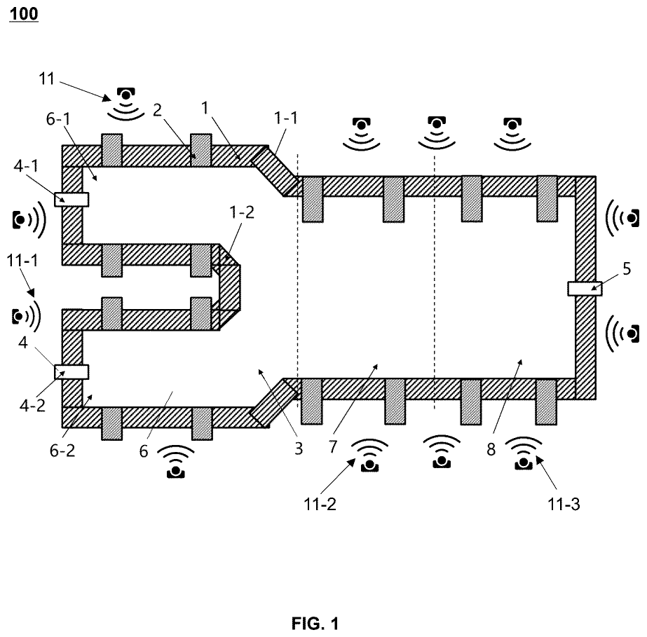

FIG. 1 is a top cross-sectional view of an exemplary front-zone dual-electrode non-equidistant kiln according to some embodiments of the present disclosure.

In some embodiments, as shown in FIG. 1, a front-zone dual-electrode non-equidistant kiln 100 (hereinafter referred to as a kiln) may include a pool wall 1. The pool wall 1 may be configured to form a clarification zone 8, a homogenization zone 7, and a plurality of pre-melting zones 6.

The pool wall 1 refers to a structure that plays a supporting and containing role in the kiln. The pool wall 1 may be constructed by a high-temperature-resistant material, such as refractory bricks.

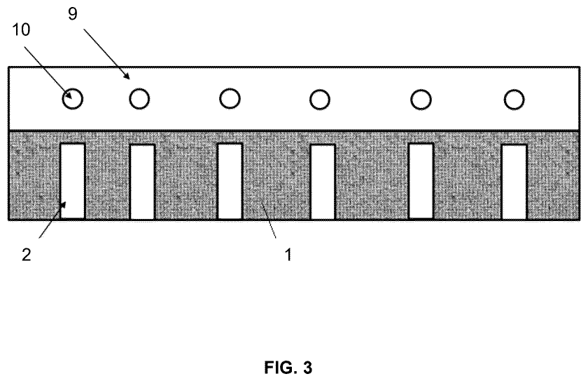

In some embodiments, the pool wall 1 is provided with a breast wall 9. More descriptions of the breast wall may be found in FIG. 3 and the related descriptions thereof.

The pre-melting zones 6 refer to regions for pre-melting of glass powder. Pre-melting refers to a process of melting glass powder at a high temperature in preparation for a subsequent complete melting and glass molding process.

In some embodiments, as shown in FIG. 1, the pre-melting zones 6 are divided into a left pre-melting zone 6-1 and a right pre-melting zone 6-2. In some embodiments, different pre-melting zones correspond to different feed ports, as may be seen in the relevant descriptions below.

In some embodiments of the present disclosure, the front zone of the kiln is configured with a dual-electrode design, i.e., a dual pre-melting zone (the left pre-melting zone 6-1 and the right pre-melting zone 6-2) are configured, so that glass powder input from different feed ports may enter the corresponding pre-melting zones for pre-melting separately. This configuration separates glass powder input from different feed ports during the pre-melting process, thereby preventing mutual interference of glass powder from different feed ports in the melting process, facilitating precise control and adjustment of the glass melting process, and improving the efficient melting of the glass powder under high flow rates.

The homogenization zone 7 refers to a zone for thorough mixing and homogenization of the molten glass. The thorough mixing and homogenization refers to a process of achieving uniformity and consistency of chemical composition and temperature in the molten glass through physical processes such as diffusion, convection, mass movement, or the like.

The clarification zone 8 refers to a zone for pre-clarification of the molten glass. The pre-clarification refers to a process of continuing to heat the molten glass to remove visible air bubbles from the molten glass.

In some embodiments, as shown in FIG. 1, the plurality of pre-melting zones 6 are in communication with the homogenization zone 7, and the homogenization zone 7 is in communication with the clarification zone 8.

In some embodiments, a transition zone 3 is formed between the pre-melting zones 6 and the homogenization zone 7. The transition zone 3 refers to a transition region between the pre-melting zones 6 and the homogenization zone 7 for isolating the pre-melting zones 6 and the homogenization zone 7.

In some embodiments, a portion of the pool wall 1 corresponding to the transition zone between the pre-melting zones 6 and the homogenization zone 7 is a transition pool wall.

In some embodiments, the transition pool wall includes an outer transition pool wall 1-1 and an inner transition pool wall 1-2. An inner surface of the outer transition pool wall 1-1 and an inner surface of the inner transition pool wall 1-2 are parallel to each other, and the outer transition pool wall 1-1 and the inner transition pool wall 1-2 are connected to corner regions of the pool wall 1 using chamfered processing.

In some embodiments of the present disclosure, the pre-melting zones 6 are isolated from the homogenization zone 7 by the transition zone 3, which prevents process interference between the pre-melting zones 6 and the homogenization zone 7. This configuration facilitates precise control and adjustment of the process for the glass powder, thereby improving the melting efficiency of the glass powder under high flow rates.

In some embodiments, a total width of the pre-melting zones 6 is greater than a width of the clarification zone 8 and a width of the homogenization zone 7. For example, the total width of the left pre-melting zone 6-1 and the right pre-melting zone 6-2 is greater than the width of the clarification zone 8, and also greater than the width of the homogenization zone 7.

In some embodiments, the width of the clarification zone 8 is equal to the width of the homogenization zone 7.

In some embodiments of the present disclosure, the total width of the pre-melting zones 6 is configured to be greater than the width of the clarification zone 8 and the width of the homogenization zone 7. This non-equidistant design of the kiln enhances the stability of an electrode power supply process, thereby further reducing the risk of in fluctuations the electrode power-on process or even failure to power-on due to fluctuations in the resistivity of the molten glass.

In some embodiments, a plurality of electrodes 2 are arranged on the pool wall 1 on two sides of each of the clarification zone 8, the homogenization zone 7, and the pre-melting zones 6.

In some embodiments, a spacing between electrodes 2 on the two sides of the pre-melting zones 6 is less than a spacing between electrodes 2 on the two sides of the clarification zone 8 and less than a spacing between electrodes 2 on the two sides of the homogenization zone 7.

An electrode 2 refers to a structure for performing electrical heating to melt glass powder. For example, the electrode 2 may include a tin electrode, a molybdenum electrode, a graphite electrode, etc.

In some embodiments, the pool wall 1 encloses an enclosed region with the electrodes 2.

In some embodiments, the electrodes 2 on the two sides of the pre-melting zone 6 are arranged at equal spacing.

In some embodiments, the plurality of electrodes 2 are equally spaced in a length direction of the kiln and a count of pairs of electrodes in each functional zone (i.e., the pre-melting zones 6, the homogenization zone 7, and the clarification zone 8) is greater than or equal to two pairs.

In some embodiments, the spacing between the electrodes 2 on the two sides of the pre-melting zones 6 is in a range of 1050 mm to 1100 mm. The range may be determined experimentally.

In some embodiments of the present disclosure, reducing the spacing between the electrodes in the pre-melting zones contributes to the stability of the kiln's electrode power supply process, reducing the risk of fluctuations in the electrode power-on process or even failure to power-on due to fluctuations in the resistivity of the molten glass, and minimizing the occurrence of the “power off” phenomenon.

In some embodiments, the electrodes 2 on the two sides of the clarification zone 8 and the electrodes 2 on the two sides of the homogenization zone 7 are arranged at equal spacing.

In some embodiments, the spacing between the electrodes 2 on the two sides of the clarification zone 8 and the spacing between the electrodes 2 on the two sides of the homogenization zone 7 are in a range of 2100 mm to 2200 mm. The range may be determined experimentally.

In some embodiments, the pool wall 1 is provided with a discharge port 5 and a plurality of feed ports 4. The plurality of feed ports 4 are in communication with the pre-melting zones 6, and the discharge port 5 is in communication with the clarification zone 8.

The feed ports 4 are entrances where the glass powder enters the kiln.

The discharge port 5 is an outlet from which the molten glass flows out after the pre-clarification is completed.

In some embodiments, the feed ports 4 and the discharge port 5 are provided on a front side and a rear side of the kiln, respectively.

In some embodiments, each of the plurality of feed ports 4 corresponds to one of the plurality of pre-melting zones 6. For example, as shown in FIG. 1, a feed port 4-1 corresponds to the pre-melting zone 6-1 and a feed port 4-2 corresponds to the pre-melting zone 6-2. In some embodiments, the glass powder input through the feed port 4-1 is pre-melted in the pre-melting zone 6-1, and the glass powder input through the feed port 4-2 is pre-melted in the pre-melting zone 6-2.

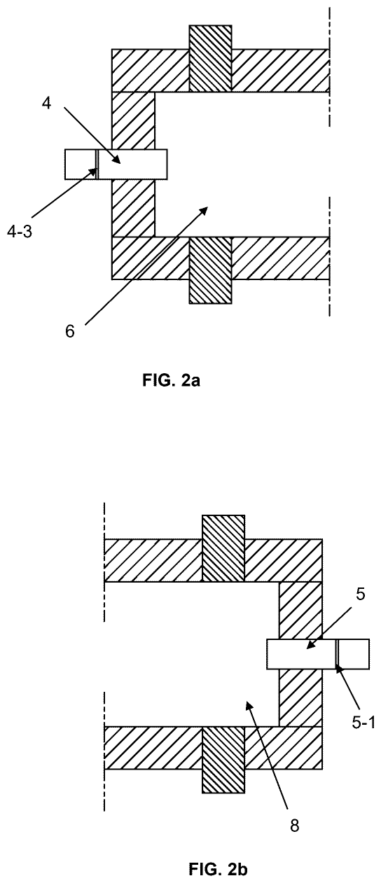

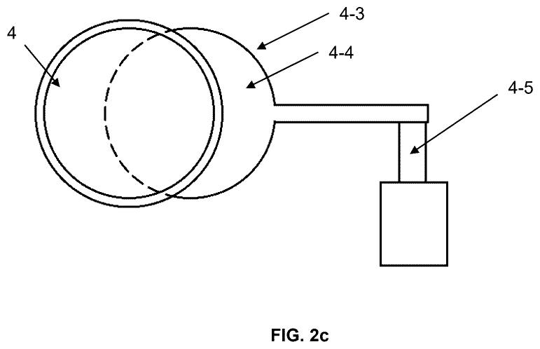

FIG. 2a is a top view of an exemplary automatic feeding gate of a front-zone dual-electrode non-equidistant kiln according to some embodiments of the present disclosure. FIG. 2b is a top view of an exemplary automatic discharge gate of a front-zone dual-electrode non-equidistant kiln according to some embodiments of the present disclosure. FIG. 2c is a side view of an exemplary automatic feeding gate of a front-zone dual-electrode non-equidistant kiln according to some embodiments of the present disclosure.

In some embodiments, as shown in FIGS. 2a and 2b, the kiln further includes a plurality of automatic feeding gates 4-3 and an automatic discharge gate 5-1. The plurality of automatic feeding gates 4-3 are provided at the plurality of feed ports 4, respectively, and configured to control a feeding speed. The automatic discharge gate 5-1 is provided at the discharge port 5 and configured to control a discharge speed.

An automatic feeding gate 4-3 refers to a device configured to automatically adjust the feeding speed of a feed port 4. In some embodiments, as shown in FIG. 2c, each of the automatic feeding gates 4-3 includes a gate 4-4 and an actuator 4-5. The gate 4-4 is disposed at the corresponding feed port 4 and fixedly connected to the actuator 4-5.

In some embodiments, the actuator 4-5 is configured to actuate the gate 4-4 to move, causing a cross-sectional area of the corresponding feed port 4 to change, thereby controlling the feed speed. The actuator 4-5 may include a motor, a cylinder, etc.

The automatic discharge gate 5-1 refers to a device configured to adjust the discharging speed of the discharge port 5. A structure and a working principle of the automatic discharge gate 5-1 are similar to the structure and the working principle of the automatic feeding gates 4-3, and will not be repeated here.

In some embodiments, the gate 4-4 may be configured in other structural forms. For example, the gate 4-4 may include a fan-shaped structure, or the like, that rotates to control an opening size of the corresponding feed port 4.

In some embodiments of the present disclosure, the plurality of feed ports 4 and the discharge port 5 are provided with the plurality of automatic feeding gates and the automatic discharge gate, respectively, which allows for adjustment of the feeding speed and discharge speed as needed during actual processing to ensure the quality of glass powder melting and the quality of the homogenization and pre-clarification of the molten glass.

In some embodiments of the present disclosure, by providing the transition zone between the pre-melting zones and the homogenization zone, configuring the total width of the pre-melting zones to be greater than the width of the clarification zone and the width of the homogenization zone, and configuring equidistant electrode spacing in the pre-melting zones, and installing the automatic feeding gates and the automatic discharge gate, efficient melting of the molten glass under high flow rates and stable kiln operation are ensured, thereby reducing the occurrence of “power off” phenomenon and enhancing the quality and efficiency of glass melting processing.

It should be noted that the descriptions of the kiln 100 are provided for illustrative purposes only and not intended to limit the scope of the present disclosure. For those of ordinary skill in the art, a wide variety of modifications or variations may be made in accordance with the descriptions in the present disclosure. For example, the kiln may further include a control device, a data acquisition device, or the like. However, these modifications or variations do not depart from the scope of the present disclosure.

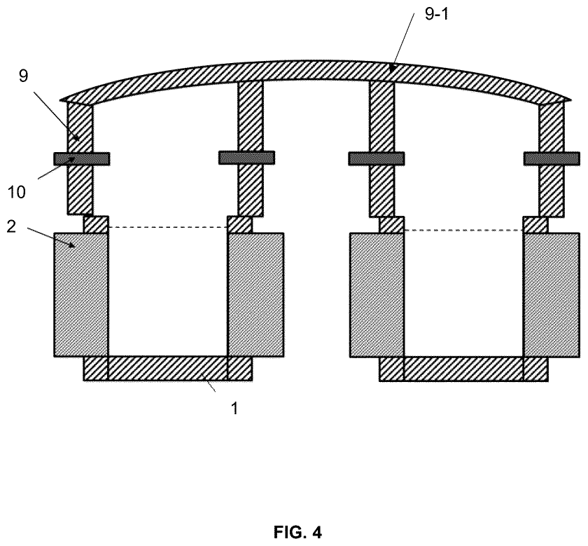

FIG. 3 is a front view of an exemplary front-zone dual-electrode non-equidistant kiln according to some embodiments of the present disclosure. FIG. 4 is a side view of an exemplary front-zone dual-electrode non-equidistant kiln according to some embodiments of the present disclosure.

In some embodiments, as shown in FIG. 3 and FIG. 4, the pool wall 1 is provided with a breast wall 9, and a crown 9-1 is arranged on the breast wall 9.

The breast wall 9 is a structure located on a side wall of the pool wall 1 that is not in direct contact with molten glass. The breast wall may be configured to support a glass melting pool, ensure the kilne's sealing, and maintain a high-temperature environment inside the kiln.

The crown is a structure located on a top of the pool wall 1. Similar to the pool wall 1, the breast wall 9 and the crown may be constructed by a high-temperature-resistant material, such as refractory bricks. The crown is configured to transfer heat, protect flame, and protect the kiln structure.

In some embodiments, the breast wall 9, the crown 9-1, and each pair of the plurality of electrodes 2 are configured to form a closed region.

In some embodiments, a plurality of burners 10 are arranged on the breast wall 9.

A burner 10 is a device configured to burn gas to achieve heating. For example, the burner 10 includes a gas lance and a flame gun. In some embodiments, an angle of each of the burners 10 may be adjusted based on process needs, or the like.

In some embodiments, a burner 10 is arranged on the breast wall 9 corresponding to a top of each electrode 2. Glass powder may be pre-melted under mixed heating of the electrodes 2 and the burners 10.

In some embodiments, the electrodes 2 and the burners 10 may also be arranged at other suitable positions, which are not limited by the present disclosure.

In some embodiments, as shown in FIG. 1, the kiln further includes a plurality of ultrasonic components 11.

An ultrasonic component 11 refers to a device that utilizes ultrasonic principles to acquire data.

In some embodiments, the plurality of ultrasonic components are arranged on an outer side of the pool wall 1 corresponding to the pre-melting zones 6, the homogenization zone 7, and the clarification zone 8. For example, as shown in FIG. 1, the plurality of ultrasonic components 11 may include one or more ultrasonic components 11-1 arranged on the outer side of the pool wall 1 corresponding to the pre-melting zones 6, one or more ultrasonic components 11-2 arranged on the outer side of the pool wall 1 corresponding to the homogenization zone 7, and one or more ultrasonic components 11-3 arranged on the outer side of the pool wall 1 corresponding to the clarification zone 8. Merely by way of example, the plurality of ultrasonic components may be arranged midway between two adjacent electrodes 2 on the outer side of the pool wall 1.

In some embodiments, each of the plurality of ultrasonic components 11 includes a transmitting unit 11-4 and a receiving unit 11-5, the transmitting unit 11-4 is configured to emit an ultrasonic wave, and the receiving unit 11-5 is configured to collect feedback ultrasonic data. The transmitting unit 11-4 may include an ultrasonic transducer, or the like, and the receiving unit 11-5 may include an ultrasonic probe, or the like.

The feedback ultrasonic data refers to data that is fed back from an emitted ultrasonic wave. For example, the feedback ultrasonic data includes an amplitude, a frequency, a phase, or the like of feedback ultrasonic waves. The feedback ultrasonic data may reflect information such as uniformity of the molten glass.

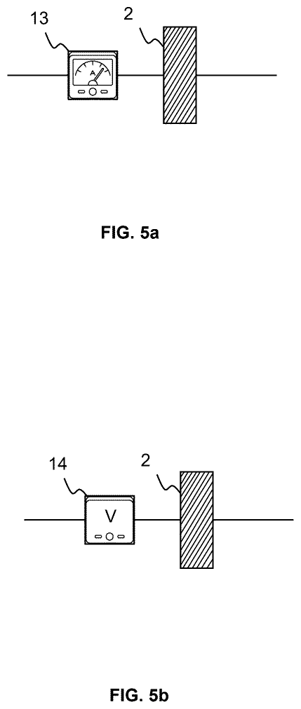

FIG. 5a is a schematic diagram showing a connection between a current measuring instrument and an electrode of an exemplary front-zone dual-electrode non-equidistant kiln according to some embodiments of the present disclosure.

In some embodiments, the kiln further comprises a plurality of current measuring instruments 13.

A current measuring instrument is an instrument that measures current data. For example, the current measuring instrument includes an ammeter, etc.

In some embodiments, as shown in FIG. 5a, each of the plurality of current measuring instruments 13 is connected in series with one of the plurality of electrodes 2 and configured to measure data of a current passing through the electrode.

FIG. 5b is a schematic diagram showing a connection between a voltage controller and an electrode of an exemplary front-zone dual-electrode non-equidistant kiln according to some embodiments of the present disclosure.

In some embodiments, the kiln further comprises a voltage controller 14. The voltage controller is connected to the plurality of electrodes 2 and configured to adjust a voltage of the plurality of electrodes 2.

The voltage controller is a device that controls or regulates voltage. The voltage controller may be configured to adjust the value of the voltage applied to the electrodes 2 according to demands.

In some embodiments, as shown in FIG. 5b, each of the plurality of electrodes 2 may be connected to the voltage controller.

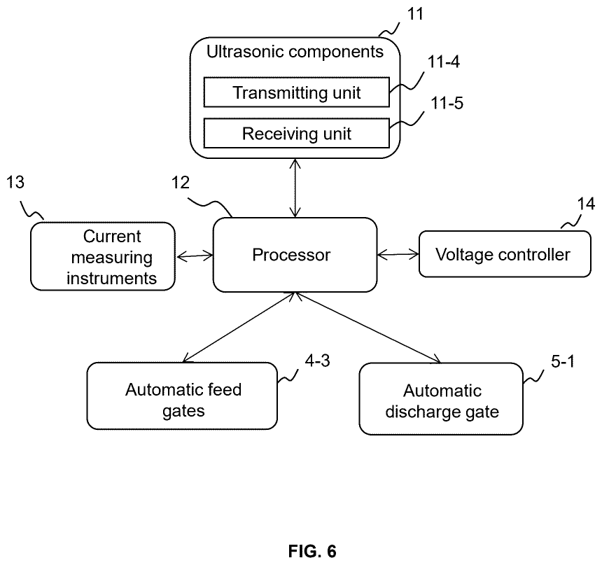

FIG. 6 is a block diagram of components of an exemplary front-zone dual-electrode non-equidistant kiln according to some embodiments of the present disclosure.

In some embodiments, the kiln further comprises a processor 12. In some embodiments, as shown in FIG. 6, the processor 12 is connected to the plurality of ultrasonic components 11, the plurality of current measuring instruments 13, the voltage controller 14, the automatic feeding gates 4-3, and the automatic discharge gate 5-1 via a signal.

The processor is configured to process data from at least one component of the kiln or an external data source. For example, the processor may acquire and analyze feedback ultrasonic data acquired by the plurality of ultrasonic components. As another example, the processor may acquire and process current data of a plurality of regions within the kiln measured by the plurality of current measuring instruments.

In some embodiments, the processor may include a central processing unit (CPU), an application-specific integrated circuit (ASIC), an application-specific instruction set processor (ASIP), etc., or any combination thereof.

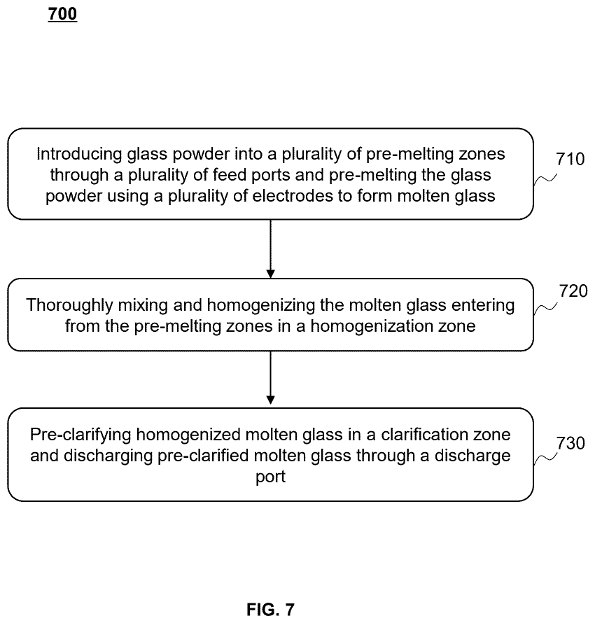

FIG. 7 is a flowchart of an exemplary process for operating a front-zone dual-electrode non-equidistant kiln according to some embodiments of the present disclosure.

As shown in FIG. 7, process 700 includes operations 710 to 730. In some embodiments, the process 700 may be performed by a control system (e.g., a controller, etc.) of the front-zone dual-electrode non-equidistant kiln, which is not limited by the embodiments of the present disclosure.

In 710, glass powder is introduced into the plurality of pre-melting zones through the plurality of feed ports, and the glass powder is pre-melted using the plurality of electrodes to form molten glass.

In some embodiments, a staff member, a robot, or the like may introduce glass powder into the pre-melting zones 6 through the feed ports 4. By setting the plurality of feed ports 4, the glass powder input from different feed ports can be separated, preventing mutual interference between the melting of the glass powder introduced from different feed ports during the pre-melting process.

In some embodiments, the glass powder introduced into the pre-melting zones 6 may be pre-melted by the electrodes 2 to form the molten glass.

Exemplarily, as shown in FIGS. 1-4, glass powder input through the left feed port 4-1 and the right feed port 4-2 enter the left pre-melting zone 6-1 and the right pre-melting zone 6-2, respectively, and the glass powder is pre-melted under the mixed heating of the electrodes 2 and the burners 10.

In 720, the molten glass entering from the pre-melting zones is thoroughly mixed and homogenized in the homogenization zone.

In some embodiments, the molten glass that has been pre-melted in the left pre-melting zone 6-1 and the right pre-melting zone 6-2 may enter into the homogenization zone 7 under an action of the outer transition pool wall 1-1 and the inner transition pool wall 1-2 to ensure that the molten glass is fully mixed and homogenized.

In some embodiments, the molten glass entering the homogenization zone 7 may be thoroughly mixed and homogenized by molecular diffusion, convective motion caused by temperature differences, or stirring induced by rising bubbles.

In 730, homogenized molten glass is pre-clarified in the clarification zone and pre-clarified molten glass is discharged through the discharge port.

In some embodiments, the molten glass after sufficient mixing and homogenization in the homogenization zone 7 enters the clarification zone 8 for pre-clarification, and flows out through the discharge port 5 after completion of the pre-clarification.

In some embodiments, pre-clarification techniques for the molten glass may include increasing a temperature of a clarification stage, extending a melting time, using a clarifying agent, applying vacuum or pressure, utilizing a sound wave or an ultrasonic wave, or the like, or any combination thereof.

In some embodiments of the present disclosure, the glass powder is pre-melted using the electrodes in the pre-melting zone to form the molten glass. The molten glass then flows from the pre-melting zone into the homogenization zone, where it is fully mixed and homogenized, and then enters the clarification zone for pre-clarification. After completing the pre-clarification, the pre-clarified molten glass flows out through the discharge port, thereby improving the quality and efficiency of glass melting.

In some embodiments, the method for operating the front-zone dual-electrode non-equidistant kiln may be executed by a processor. The method may further comprise: measuring current data of a plurality of regions in the front-zone dual-electrode non-equidistant kiln using a plurality of current measuring instruments; determining a plurality of resistivity values of the molten glass corresponding to the plurality of regions based on the current data of the plurality of regions, a dimension of the front-zone dual-electrode non-equidistant kiln, and a depth of the molten glass; determining a first resistance parameter during a glass melting process based on the plurality of resistivity values; determining a first feed parameter and a first discharge parameter based on the first resistance parameter; and sending the first feed parameter and the first discharge parameter to a plurality of automatic feeding gates and an automatic discharge gate, respectively, to control a feeding speed and a discharge speed.

The plurality of regions refer to regions obtained by dividing the front-zone dual-electrode non-equidistant kiln based on midpoints between positions of two adjacent electrodes of the kiln. In some embodiments, one electrode corresponds to one region.

The current data of a region refers to a magnitude of a current passing through the molten glass in the region under an action of the electrode corresponding to the region.

In some embodiments, the processor may obtain the current data of the plurality of regions based on measurements from the plurality of current measuring instruments configured in the plurality of regions.

The dimension of the kiln includes information such as a width, a length, or the like of each of the plurality of regions of the kiln. In some embodiments, the processor may determine the dimension of the kiln by techniques such as laser ranging, image recognition, etc.

In some embodiments, the processor may obtain the depth of the molten glass by measuring using a laser glass level meter. The laser glass level meter may be mounted on a top of the kiln to measure the depth of the molten glass.

In some embodiments, the processor may determine dimensional information of the molten glass in different regions based on the dimension of the kiln and the depth of the molten glass. The dimensional information of the molten glass includes a length, a cross-sectional area, or the like of the molten glass. In some embodiments, the processor may determine electrical resistance of the molten glass by Ohm's law based on the current data and voltage data of a voltage applied to the electrodes. In some embodiments, the processor may determine the resistivity values of the molten glass based on the electrical resistance of the molten glass and the dimensional information of the molten glass via a resistivity equation. In some embodiments, the resistivity may be real-time resistivity. The processor may determine the plurality of resistivity values corresponding to the plurality of regions through the above manners.

The first resistance parameter refers to a resistivity stability during a present glass melting process. The resistivity stability refers to data characterizing the stability of the resistivity values.

In some embodiments, the first resistance parameter is negatively correlated with a resistivity change magnitude and a resistivity change gradient in the plurality of regions. For example, the processor may determine the first resistance parameter using a preset equation, which may be represented as:

$$S = 1 / ( R * G ) . \qquad ( 1 )$$

In Eq. (1), S denotes the first resistance parameter, R denotes the resistivity change magnitude, and G denotes the resistivity change gradient.

In some embodiments, the processor may determine the first resistance parameter in other ways that indicate a negative correlation between the first resistance parameter and the resistivity change magnitude and the resistivity change gradient, which are not limited in the present disclosure.

In some embodiments, to determine the first resistance parameter during the glass melting process based on the plurality of resistivity values, the processor is configured to: generate an ultrasonic detection parameter and send the ultrasonic detection parameter to the ultrasonic components arranged on an outer side of the pool wall corresponding to the plurality of pre-melting zones; control the ultrasonic components to emit test ultrasonic waves based on the ultrasonic detection parameter and collect feedback ultrasonic data; and determine the first resistance parameter based on the feedback ultrasonic data and the plurality of resistivity values.

The ultrasonic detection parameter is a parameter that controls the ultrasonic components to emit the test ultrasonic waves. For example, the ultrasonic detection parameter may include an ultrasonic frequency, an ultrasonic amplitude, an ultrasonic emission time, or the like.

In some embodiments, the plurality of ultrasonic components emit ultrasonic waves at different ultrasonic emission times and collect the feedback ultrasonic data sequentially to avoid mutual interference.

In some embodiments, the amplitude of the ultrasonic detection parameter does not exceed a predetermined amplitude threshold to avoid too much impact on the molten glass, which may result in inaccurate feedback ultrasonic data. The predetermined amplitude threshold may be determined empirically.

In some embodiments, the ultrasonic detection parameter may be pre-stored and directly called by the processor. In some embodiments, the ultrasonic detection parameter may be pre-determined by a user based on a structure, a material, or the like of the kiln and stored in a storage device.

The test ultrasonic waves refer to ultrasonic waves used for testing to determine the first resistance parameter of the molten glass.

More descriptions of the feedback ultrasonic data may be found in FIG. 2 and the related descriptions thereof.

In some embodiments, the processor may send the ultrasound detection parameter to the ultrasonic components. A transmitting unit of each of the ultrasonic components may be configured to emit a test ultrasound wave based on the ultrasonic frequency, the ultrasonic amplitude, and the ultrasonic emission time in the ultrasound detection parameter, and a receiving unit of each of the ultrasonic components may be configured to collect a set of feedback ultrasonic data.

In some embodiments, the processor may determine a difference between any two sets of feedback ultrasonic data based on a plurality of sets of feedback ultrasonic data collected by the receiving units of different ultrasonic components. In some embodiments, the processor may determine a uniformity coefficient based on a variance of a plurality of differences between a plurality of sets of feedback ultrasonic data, correct the first resistance parameter based on the uniformity coefficient, and determine a target resistance parameter.

The uniformity coefficient may be determined using Equation (2):

$$A = 1 + V / F . \qquad ( 2 )$$

In Eq. (2), A denotes the uniformity coefficient, V denotes the variance of the plurality of differences between the plurality of sets of feedback ultrasonic data, and F denotes a mean value of the plurality of sets of feedback ultrasonic data.

Understandably, the variance of the plurality of differences between the plurality of sets of feedback ultrasonic data may reflect a degree of uniformity between the molten glass and a cold material in the pre-melting zones 6. The larger the variance of the differences is, the less uniform the molten glass is in the pre-melting zones 6, making the resistivity more prone to variation, which indicates a decline in resistivity stability.

In some embodiments, the processor may correct the first resistance parameter based on the uniformity coefficient using equation (3):

$${S}_{1} = S / ( 1 + A ) . \qquad ( 3 )$$

In Eq. (3), S₁ denotes the target resistance parameter, S denotes the first resistance parameter, and A denotes the uniformity coefficient.

In some embodiments, the processor may correct the first resistance parameter through other manners based on the uniformity coefficient, which is not limited in the present disclosure.

In some embodiments of the present disclosure, by obtaining the feedback ultrasonic data of the pre-melting zones 6 through the ultrasonic components and further correcting the first resistance parameter based on the feedback ultrasonic data, a more accurate first resistance parameter can be obtained, and the resistivity stability in the pre-melting zones 6 can be better evaluated.

The first feed parameter is a parameter used to control the feeding speed of the glass powder through the feed ports 4 during the present glass melting process. The feed parameter may include an opening size of the automatic feeding gate 4-3 of each of the feed ports 4.

The first discharge parameter is a parameter for controlling the discharge speed of the molten glass through the discharge port 5 during the present glass melting process. The discharge parameter may include an opening size of the automatic discharge gate of the discharge port 5.

In some embodiments, the processor may determine the first feed parameter and the first discharge parameter based on the first resistance parameter.

In some embodiments, the processor may control, based on the first feed parameter or the first discharge parameter, the opening size of the automatic feeding gates 4-3 and the opening size of the automatic discharge gate, thereby controlling the feeding speed and the discharge speed of the present glass melting process.

In some embodiments, the processor may determine a homogenization degree of the molten glass within the homogenization zone 7 based on the first resistance parameter, and determine the first feed parameter and the first discharge parameter based on the homogenization degree of the molten glass in different regions within the homogenization zone 7. The homogenization degree of the molten glass characterizes a degree of homogenized mixing of the molten glass.

In some embodiments, the processor may determine a difference between a plurality of first resistance parameters of the plurality of pre-melting zones 6 at a same time and construct a difference feature vector based on the difference. The processor may retrieve information from a homogenization degree database based on the difference feature vector to determine the homogenization degree of the molten glass in different regions of the homogenization zone 7.

The homogenization degree database stores a plurality of different reference difference feature vectors and a plurality of sets of reference homogenization degrees corresponding to the plurality of different reference difference feature vectors, wherein each set of reference homogenization degrees includes homogenization information of the different regions of the homogenization zone 7. In some embodiments, the homogenization degree database may be constructed based on historical data collected during a historical glass melting process or may be determined by simulation experiments, which are not limited by the present disclosure.

In some embodiments, in response to determining that the homogenization degree of the molten glass does not satisfy a discharge condition and the first resistance parameter is less than a stability threshold, the processor may reduce the opening size of the automatic feeding gates and close the automatic discharge gate. The stability threshold may be determined empirically.

By reducing the opening size of the automatic feeding gates and closing the automatic discharge gate, the feeding speed can be lowered, and no discharge occurs, thereby extending a homogenization duration to ensure the molten glass is fully homogenized.

The discharge condition may include the homogenization degree of the molten glass being below a predetermined homogenization threshold. The homogenization threshold may be determined based on experience.

In some embodiments, in response to determining that the homogenization degree of the molten glass satisfies the discharge condition but the first resistance parameter is less than the stability threshold, the processor may reduce the opening size of the automatic feeding gates and maintain the opening size of the automatic discharge gate unchanged.

By reducing the opening size of the automatic feeding gates and keeping the opening size of the automatic discharge gate constant, fully homogenized molten glass can be prevented from mixing with subsequent incompletely homogenized molten glass.

In some embodiments, when the first resistance parameter is greater than or equal to the stability threshold, the processor may restore the feed parameter and the discharge parameter to set default values.

In some embodiments of the present disclosure, by determining the first resistance parameter during the glass melting process and using the first resistance parameter to assess the homogenization degree of the molten glass in the homogenization zone, adjustments to the first feed parameter and the first discharge parameter can be made promptly based on the first resistance parameter when the homogenization degree and/or the resistivity stability do not satisfy required conditions. This allows control the feeding speed and the discharge speeds. By regulating the feeding speed and the discharge speeds, the melting and homogenization durations of the molten glass can be extended, thereby preventing uneven melting and homogenization, and improving the quality of the molten glass.

In some embodiments, the method for operating the front-zone dual-electrode non-equidistant kiln is executed by a processor and the method further comprises: obtaining a second feed parameter for a next feeding and a second discharge parameter of the molten glass; predicting a second resistance parameter for the next feeding based on the second feed parameter, the second discharge parameter, and a present electrode voltage; determining an electrode melting parameter based on the second resistance parameter; and sending the electrode melting parameter to a voltage controller to adjust a voltage of the plurality of electrodes.

The next feeding refers to a feeding process after a present feeding is completed.

The second feed parameter refers to a feed parameter for the next feeding. For example, the second feed parameter may include an opening size of the automatic feeding gates of the feed ports 4 for the next feeding.

The second discharge parameter refers to a discharge parameter for the molten glass produced corresponding to the next feeding of the glass powder. For example, the second discharge parameter may include an opening size of the automatic discharge gate of the discharge port 5 after the next feeding.

In some embodiments, the processor may obtain the second feed parameter and the second discharge parameter through monitoring. For example, the processor may obtain the opening size of the automatic feeding gates and the opening size of the automatic discharge gate during the next feeding through a monitoring device (e.g., an image recognition device, a rangefinder, etc.), and designate the obtained opening size of the automatic feeding gates and the opening size of the automatic discharge gate as the second feed parameter and the second discharge parameter, respectively.

In some embodiments, the processor may predict, based on the second feed parameter, the second discharge parameter, and the present electrode voltage, the second resistance parameter for the next feeding through a predetermined algorithm. The predetermined algorithm may include a machine learning model, a particle swarm algorithm, a genetic algorithm, or the like.

The present electrode voltage refers to an electrode voltage at a present moment.

The second resistance parameter refers to a resistivity stability at the next feeding, i.e., the resistivity stability of the molten glass at a future moment corresponding to the next feeding.

In some embodiments, the processor may determine the second resistance parameter based on the second feed parameter, the second discharge parameter, the present electrode voltage, and a feedback ultrasonic image through a resistance prediction model.

The feedback ultrasonic image refers to an ultrasonic image of the entire kiln generated based on the feedback ultrasonic data. The feedback ultrasonic image may reflect the homogenization degree of the molten glass within the entire kiln.

In some embodiments, the processor may generate a feedback ultrasonic sub-image based on a set of feedback ultrasonic data corresponding to a region inside the kiln through image reconstruction. In some embodiments, the processor may use an image stitching technique to combine a plurality of feedback ultrasonic sub-images corresponding to the plurality of regions, thereby obtaining a complete feedback ultrasonic image.

The resistance prediction model may be a machine learning model or the like. For example, the resistance prediction model may be a Deep Neural Network (DNN) model or the like.

In some embodiments, the resistance prediction model may include a feature layer and a prediction layer. The feature layer and the prediction layer may be a Convolutional Neural Network (CNN), a Deep Neural Network (DNN), or the like.

In some embodiments, the feature layer may be configured to process the feedback ultrasonic image to output a uniformity feature of the molten glass. The prediction layer may be configured to process the uniformity feature, the second feed parameter, the second discharge parameter, and the present electrode voltage to output the second resistance parameter.

In some embodiments, the resistance prediction model may be obtained by jointly training the feature layer and the prediction layer. Training techniques may include a gradient descent technique, or the like.

In some embodiments, training samples may include a historical feedback ultrasonic image, a historical feed parameter, a historical discharge parameter, a historical electrode voltage, and labels may include historical resistivity stabilities corresponding to the training samples.

In some embodiments, the processor may input historical feedback ultrasonic data into an initial feature layer to obtain an initial uniformity feature, input the initial uniformity feature, the historical feed parameter, the historical discharge parameter, and the historical electrode voltage into an initial prediction layer to obtain an initial second resistance parameter. In some embodiments, the processor may construct a loss function based on the initial second resistance parameter and the labels, and synchronously update the initial feature layer and the initial prediction layer based on the loss function. The processor may obtain a trained resistance prediction model through parameter updates.

The electrode melting parameter refers to an electrical parameter applied when the electrodes melt the glass powder. For example, the electrode melting parameter may include a voltage applied to the electrodes and an execution time of the voltage.

In some embodiments, the processor may determine the electrode melting parameter by comparing the second resistance parameter with the preset stability threshold. For example, when the second resistance parameter falls below the stability threshold, the processor may adjust the voltage applied to the electrodes based on a preset amplitude and set the start of the next feeding as the execution time of the voltage. In some embodiments, the processor may determine the preset amplitude based on a difference between the second resistance parameter and the stability threshold. For example, the processor may determine a percentage of the difference between the second resistance parameter and the stability threshold as the preset amplitude.

In some embodiments, the processor may send the electrode melting parameter to a voltage controller of the kiln. The voltage controller is configured to adjust the voltage of the electrodes based on the electrode melting parameter.

In some embodiments of the present disclosure, by determining the resistivity stability of the molten glass before the next feeding, it is possible to predict fluctuation in resistivity and adjust the electrode melting parameter in advance, before the actual feeding and discharging. This helps avoid fluctuations in the molten glass's resistivity caused by feeding and discharging, ensuring the quality of glass melting. By adjusting the voltage of the electrodes in a timely manner when the resistivity stability is too low, the processor ensures the thorough melting of the glass powder, thereby improving the efficiency of glass powder melting.

In some embodiments, the method for operating the front-zone dual-electrode non-equidistant kiln further comprises: generating an ultrasonic speed control parameter based on the second resistance parameter and sending the ultrasonic speed control parameter to an ultrasonic component; controlling the ultrasonic component to emit speed-control sound waves based on the ultrasonic speed control parameter; and adjusting a flow velocity of the molten glass in the front-zone dual-electrode non-equidistant kiln based on the speed-control sound waves.

The ultrasonic speed control parameter refers to a parameter that controls the ultrasonic component to emit speed-control sound waves. For example, the ultrasonic speed control parameter may include an ultrasonic component that emits the speed-control sound wave, a frequency and amplitude of the speed-control sound wave, or the like.

The speed-control sound waves refer to ultrasonic waves for controlling the flow velocity of the molten glass. The speed-control sound wave may include a decelerating sound wave and an accelerating sound wave.

In some embodiments, the decelerating sound wave may be emitted by an ultrasonic component measured at the clarification zone outlet. If there is a need to slow down the flow of the molten glass, the processor may control an ultrasonic component on a side of the discharge port at the clarification zone to emit the deceleration sound wave to slow down the flow of the molten glass to the clarification zone.

In some embodiments, the accelerating sound wave may be emitted by an ultrasonic component on a side of the feed port of the pre-melting zone. If there is a need to accelerate the flow of the molten glass, the processor may control the ultrasonic component on the side of the feed port of the pre-melting zone to emit the accelerating sound wave to accelerate the flow of the molten glass to the clarification zone.

In some embodiments, the processor may retrieve a pre-stored ultrasonic speed control parameter directly from the storage device. In some embodiments, the ultrasonic speed control parameter may be determined by the user based on experience and actual glass melting needs, and uploaded to the storage device for storage.

In some embodiments, to generate the ultrasonic speed control parameter based on the second resistance parameter, the processor may be configured to compare the second resistance parameter with the preset stability threshold, and retrieve the corresponding ultrasonic speed control parameter from the processor based on a comparison result. More descriptions of the preset stability threshold may be found in the related descriptions above.

In some embodiments, the processor may control the ultrasonic component to emit the speed-control sound waves based on the ultrasonic speed-control parameter.

In some embodiments, in response to determining that the second resistance parameter is less than the stability threshold, the processor may retrieve the ultrasonic speed control parameter corresponding to the decelerating sound wave from the storage device during the next feeding, in order to emit the decelerating sound wave to slow down the flow velocity of the molten glass.

In some embodiments, in response to determining that the second resistance parameter is greater than the stability threshold, the processor may retrieve the ultrasonic speed control parameter corresponding to the accelerating sound wave from the processor during the next feeding, in order to emit the accelerating sound wave to increase the flow velocity of the molten glass.

In some embodiments, the processor may continuously monitor and obtain resistance parameters of the molten glass. When the monitored resistance parameters stabilize within a preset stability range, the processor may stop emitting the speed-control sound waves to allow the molten glass to melt and flow naturally. The stability range refers to a resistance range when the resistivity reaches stability. In some embodiments, the stability range may be a numerical range centered around the stability threshold, and a size of the range is positively correlated with the value of the voltage presently applied to the electrodes.

In some embodiments of the present disclosure, by setting the stability range, resistivity may fluctuate within a certain range, allowing for greater flexibility in adjusting the feed parameter, the discharge parameter, the electrode voltage, or the like based on the resistivity stability.

In some embodiments of the present disclosure, controlling the flow velocity of the molten glass by emitting the speed-controlled sound waves from the ultrasonic component can slow down the flow velocity of the molten glass when the resistivity stability is lower than the stability threshold, thereby allowing the molten glass to be sufficiently melted, homogenized, and clarified to improve the quality of the molten glass. When the resistivity stability is higher than the resistivity threshold, the flow velocity of the molten glass is increased to improve the melting efficiency of the molten glass. In addition, by applying ultrasonic waves to the molten glass, the efficiency of melting, homogenization, and clarification can be improved with the aid of ultrasonic energy.

Understandably, the automatic feeding gate and automatic discharge gate may only immediately affect the molten glass in the pre-melting zones and the clarification zone, but may not immediately regulate the flow of the molten glass, which may result in the flow of insufficiently homogenized molten glass into the clarification zone, thus affecting the quality of the discharged molten glass. The ultrasonic speed control ensures that the molten glass flows to the clarification zone after it is fully homogenized, which guarantees the quality of the discharged molten glass.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended for those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or features may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

It should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This way of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameter set forth in the written description and attached claims are approximations that may vary depending upon the desired properties sought to be obtained by a particular embodiment. In some embodiments, the numerical parameter should be construed in light of the count of reported significant digits and by applying ordinary rounding techniques. Notwithstanding that the numerical ranges and parameter setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrating of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A front-zone dual-electrode non-equidistant kiln, comprising a pool wall, the pool wall is configured to form a clarification zone, a homogenization zone, and a plurality of pre-melting zones, wherein
the plurality of pre-melting zones are in communication with the homogenization zone, the homogenization zone is in communication with the clarification zone, a total width of the pre-melting zones is greater than a width of the clarification zone and a width of the homogenization zone,
a plurality of electrodes are arranged on the pool wall on two sides of each of the clarification zone, the homogenization zone, and the pre-melting zones, a spacing between electrodes on the two sides of the pre-melting zones is less than a spacing between electrodes on the two sides of the clarification zone and a spacing between electrodes on the two sides of the homogenization zone,
the pool wall is provided with a discharge port and a plurality of feed ports, the plurality of feed ports are in communication with the pre-melting zones, and the discharge port is in communication with the clarification zone.

2. The front-zone dual-electrode non-equidistant kiln of claim 1, wherein a transition zone is formed between the pre-melting zones and the homogenization zone.

3. The front-zone dual-electrode non-equidistant kiln of claim 2, wherein the electrodes on the two sides of the pre-melting zones are arranged at equal spacing.

4. The front-zone dual-electrode non-equidistant kiln of claim 3, wherein the spacing between the electrodes on the two sides of the pre-melting zones is in a range of 1050 mm to 1100 mm.

5. The front-zone dual-electrode non-equidistant kiln of claim 1, wherein the width of the clarification zone is equal to the width of the homogenization zone.

6. The front-zone dual-electrode non-equidistant kiln of claim 5, wherein the electrodes on the two sides of the clarification zone and the electrodes on the two sides of the homogenization zone are arranged at equal spacing.

7. The front-zone dual-electrode non-equidistant kiln of claim 6, wherein the spacing between the electrodes on the two sides of the clarification zone and the spacing between the electrodes on the two sides of the homogenization zone are in a range of 2100 mm to 2200 mm.

8. The front-zone dual-electrode non-equidistant kiln of claim 1, wherein the pool wall is provided with a breast wall, and a crown is arranged on the breast wall.

9. The front-zone dual-electrode non-equidistant kiln of claim 8, wherein a plurality of burners are arranged on the breast wall.

10. The front-zone dual-electrode non-equidistant kiln of claim 1, further comprising a plurality of ultrasonic components, wherein
the plurality of ultrasonic components are arranged on an outer side of the pool wall corresponding to the pre-melting zones, the homogenization zone, and the clarification zone,
each of the plurality of ultrasonic components includes a transmitting unit and a receiving unit, the transmitting unit is configured to emit an ultrasonic wave, and the receiving unit is configured to collect feedback ultrasonic data.

11. The front-zone dual-electrode non-equidistant kiln of claim 1, further comprising a plurality of current measuring instruments, wherein each of the plurality of current measuring instruments is connected in series with one of the plurality of electrodes and configured to measure data of a current passing through the electrode.

12. The front-zone dual-electrode non-equidistant kiln of claim 1, further comprising a voltage controller, wherein the voltage controller is connected to the plurality of electrodes and configured to adjust a voltage of the plurality of electrodes.

13. The front-zone dual-electrode non-equidistant kiln of claim 1, further comprising a plurality of automatic feeding gates and an automatic discharge gate; wherein
the plurality of automatic feeding gates are provided at the plurality of feed ports, respectively, and configured to control a feeding speed, and
the automatic discharge gate is provided at the discharge port and configured to control a discharge speed.

14. The front-zone dual-electrode non-equidistant kiln of claim 1, further comprising a processor that is communicatively connected with a plurality of ultrasonic components, a plurality of current measuring instruments, a voltage controller, a plurality of automatic feeding gates, and an automatic discharge gate.

15. A method for operating a front-zone dual-electrode non-equidistant kiln, wherein
the front-zone dual-electrode non-equidistant kiln comprises a pool wall, the pool wall is configured to form a clarification zone, a homogenization zone, and a plurality of pre-melting zones, wherein
the plurality of pre-melting zones are in communication with the homogenization zone, the homogenization zone is in communication with the clarification zone, a total width of the pre-melting zones is greater than a width of the clarification zone and a width of the homogenization zone,
a plurality of electrodes are arranged on the pool wall on two sides of each of the clarification zone, the homogenization zone, and the pre-melting zones, a spacing between electrodes on the two sides of the pre-melting zones is less than a spacing between electrodes on the two sides of the clarification zone and a spacing between electrodes on the two sides of the homogenization zone,
the pool wall is provided with a discharge port and a plurality of feed ports, the plurality of feed ports are in communication with the pre-melting zones, and the discharge port is in communication with the clarification zone, and
the method comprises:
introducing glass powder into the plurality of pre-melting zones through the plurality of feed ports and pre-melting the glass powder using the plurality of electrodes to form molten glass;
thoroughly mixing and homogenizing the molten glass entering from the pre-melting zones in the homogenization zone; and
pre-clarifying homogenized molten glass in the clarification zone and discharging pre-clarified molten glass through the discharge port.

16. The method of claim 15, the method being executed by a processor and further comprising:
measuring current data of a plurality of regions in the front-zone dual-electrode non-equidistant kiln using a plurality of current measuring instruments;
determining a plurality of resistivity values of the molten glass corresponding to the plurality of regions based on the current data of the plurality of regions, a dimension of the front-zone dual-electrode non-equidistant kiln, and a depth of the molten glass;
determining a first resistance parameter during a glass melting process based on the plurality of resistivity values;
determining a first feed parameter and a first discharge parameter based on the first resistance parameter; and
sending the first feed parameter and the first discharge parameter to a plurality of automatic feeding gates and an automatic discharge gate, respectively, to control a feeding speed and a discharge speed.

17. The method of claim 16, wherein the determining a first resistance parameter during a glass melting process based on the plurality of resistivity values includes:
generating an ultrasonic detection parameter and sending the ultrasonic detection parameter to a plurality of ultrasonic components arranged on an outer side of the pool wall corresponding to the plurality of pre-melting zones;
controlling the plurality of ultrasonic components to emit test ultrasonic waves based on the ultrasonic detection parameter and collect feedback ultrasonic data; and
determining the first resistance parameter based on the feedback ultrasonic data and the plurality of resistivity values.

18. The method of claim 15, the method being executed by a processor and further comprising:
obtaining a second feed parameter for a next feeding and a second discharge parameter of the molten glass;
predicting a second resistance parameter for the next feeding based on the second feed parameter, the second discharge parameter, and a present electrode voltage;
determining an electrode melting parameter based on the second resistance parameter; and
sending the electrode melting parameter to a voltage controller to adjust a voltage of the plurality of electrodes.

19. The method of claim 18, further comprising:
generating an ultrasonic speed control parameter based on the second resistance parameter and sending the ultrasonic speed control parameter to a plurality of ultrasonic components;
controlling the plurality of ultrasonic components to emit speed-control sound waves based on the ultrasonic speed control parameter; and
adjusting a flow velocity of the molten glass in the front-zone dual-electrode non-equidistant kiln based on the speed-control sound waves.

20. A non-transitory computer-readable storage medium storing computer instructions, wherein when the computer instructions are executed by a processor, the processor implements a method for operating a front-zone dual-electrode non-equidistant kiln, wherein
the front-zone dual-electrode non-equidistant kiln comprises a pool wall, the pool wall is configured to form a clarification zone, a homogenization zone, and a plurality of pre-melting zones, wherein
the plurality of pre-melting zones are in communication with the homogenization zone, the homogenization zone is in communication with the clarification zone, a total width of the pre-melting zones is greater than a width of the clarification zone and a width of the homogenization zone,
a plurality of electrodes are arranged on the pool wall on two sides of each of the clarification zone, the homogenization zone, and the pre-melting zones, a spacing between electrodes on the two sides of the pre-melting zones is less than a spacing between electrodes on the two sides of the clarification zone and a spacing between electrodes on the two sides of the homogenization zone,
the pool wall is provided with a discharge port and a plurality of feed ports, the plurality of feed ports are in communication with the pre-melting zones, and the discharge port is in communication with the clarification zone, and
the method comprises:
introducing glass powder into the plurality of pre-melting zones through the plurality of feed ports and pre-melting the glass powder using the plurality of electrodes to form molten glass;
thoroughly mixing and homogenizing the molten glass entering from the pre-melting zones in the homogenization zone; and
pre-clarifying homogenized molten glass in the clarification zone and discharging pre-clarified molten glass through the discharge port.
